(19) United States
(12) Patent Application Publication
(10) Pub. No.: US 2011/0042170 A1
(43) Pub. Date: Feb. 24, 2011

(54) LIFT WITH BALANCING WEIGHT

(76) Inventor: Luciano Faletto, Milan (IT)

Correspondence Address: DILWORTH & BARRESE, LLP, 1000 WOODBURY ROAD, SUITE 405, WOODBURY, NY, 11797, US

(21) Appl. No.: 12/521,399

(22) PCT Filed: Dec. 24, 2007
(86) PCT No.: PCT/IB2007/004475

§ 371 Date: Nov. 8, 2010

(30) Foreign Application Priority Data
Dec. 29, 2006 (IT) MI2006A002544

(51) Int. Cl. B66B 11/08; B66B 7/08

(52) U.S. Cl. 187/266; 187/411

(57) ABSTRACT

The present invention refers to a configuration of the pulleys and ropes so as to obtain the cage (21) suspension of the size ratio type at least equal to 1:2 or greater (1:4, 1:6, 1:8, etc) and the suspension of a balance weight (14) always equal to 1:2 in size ratio, formed such that the path of the balance weight is equal to the path of the cage. The ropes going from the traction pulley (2) towards the balance weight pass between the pulleys placed on the cage and the pulleys (5, 8) placed in the lower portion of the shaft, such that the portion of the size ratio not obtained between the balance weight and the upper portion of the shaft is realized between the cage and the lower portion of the shaft, so as to equalize on the whole the size ratio between the cage and the upper portion of the shaft. Advantageously, the invention can be provided with segmented dowelling of the pulley races and insertion undercut.

The present invention relates to systems for maximizing the cage size in lift plants by substituting the counterweight with a balance weight.

During the disclosure reference will indifferently made to flat belts with stiffener ropes, grooved belts with stiffener ropes and circular section ropes or more simply ropes, as possible examples of suspension elongated elements.

A problem to be solved, in order to make cheaper and more effective the manufacture of lifts, consists in compacting to the maximum all the auxiliary apparatuses to be installed in the lift shaft, even when lifts without machine room have to be manufactured. That is in order to maximize the cage size, in a lift shaft small in size, for allowing a greater usable capacity, especially when preexistent plants have to be renewed with a lift shaft not modifiable in width and for allowing a better accessibility even for handicapped users. In order to obtain that result different elements can specifically modified, especially those having on plan a bulk in the lift shaft. This problem is faced for a long time and several solutions have just been supposed, which actually present many contraindications.

A method to reduce the number of the ropes wrapped around the pulleys and so the thickness of the same pulleys consists in increasing the size ratio of the lift suspension, this allowing to halve the rope number or even to reduce it further. The increasing of the size ratio, by the decreasing of rope number, has the further advantage; as well as reducing the thickness of the pulleys, around which the ropes are wrapped, particularly the traction pulley, of reducing also the size of the driving machine. This, in many situations, allows a great reduction of the bulk being to advantage of the cage size increasing. The size increasing leads, under the same power, to a speed increasing, due to less torque on each pulley. This implies the need to increase friction between ropes and pulleys. This further problem, below disclosed, can be solved by increasing the wrap angle or suitable expedients relating dowelling of the pulley races by an improved friction material.

It can be suggested to adopt the easiest solution to be realized for the application of the traction load on the driven branch of the ropes, the branch of the rope not assigned to the cage suspension, defining a fixed value of the traction load, by suitable weight, and/or similar device with spring and/or motorized, or similar. This solution could became even more advantageous if a secondary deflecting pulley would be applied, formed with races assuring traction parameters similar to the ones of the traction pulley, and the wrapping rope system, that can be called ISW (Improved Single Wrap) disclosed in a document of the same Applicant filed concurrently with the present one consisting in wrapping the ropes around the pulley into a range of angles comprised about from 200° to 300°, so as to increase friction (which as known is also proportional to the wrapping angle of the rope around the pulleys) and with entry and exit of the ropes placed on the deflecting pulley, so as to displace the motor and corresponding pulley in a hollow accessible from outside or inside the lift shaft, with no bulks in it. Similarly the known DW (Double wrap) wrapping system or also the wrapping rope system called IDW (Improved Double Wrap), disclosed in the above mentioned Applicant's document, can be advantageously applied, consisting in wrapping the ropes around the pulley in a range of angles comprised about from 380° to 510° around the deflecting pulley and with entry and exit of the ropes placed on the deflecting pulley, so as to place the motor and corresponding pulley in a hollow accessible from outside or inside the lift shaft, with no bulks in it.

However the absence of the counterweight and seeking of the maximum reduction of the weights may require friction parameters not achievable even by the configuration called ISW or IDW. In such case a compromise can be advantageously be applied, between the situation without any counterweight and the solution balancing completely the cage weight besides a percentage of the useful load, i.e. a balance weight can be applied. The solution herein proposed provides therefore the application of a balance weight. The lift type proposed is characterized by having the cage suspension of the size ratio type at least equal to 1:2 (or eventually greater: 1:4, 1:6, 1:8, etc) and the balance weight suspension always with a 1:2 ratio, realized such that the counterweight stroke is equal to the lift stroke.

Herein the size ratio is indicated by a notation referring to the ratio between the speed of the mass to be moved and the one of the suspension elongated element, thus 1:2, 1:4, 1:6 etc.

It need to be clarified that in the following disclosure balance weight is referred not to a counterweight, which balances the mass of the cage and a portion of the load moved by it, but a mass balancing only partially the only cage mass, this according also to the definition present in the European Norms for lifts EN 81-1.

In such manner, independently from the cage load conditions, the unbalancing of the plant is always able to assure the cage descent. This advantageously reduces the need of safety devices for a uncontrolled cage movement during lifting. This allows further advantageously to use speed control, devices of the plant less complex, since the torque direction generated by unbalanced load is unique, therefore the driving or braking torque of the driving motor is given by the movement direction, without the unknown commonly due to the cage load condition.

Another feature of the proposed solution consists in adopting for the balance weight a size ratio equal to 1:2, equal or lower rather than the one adopted for the cage suspension. This expedient has the additional advantage that, under the same friction conditions of the suspension elongated elements on the traction pulley, the balance weight size are further contained, from about 30% up to 60%, as advantage of a better use of the spaces inside the lift shaft to obtain the maximum possible size of the cage. Moreover the displacement of the beams and pulleys in the top of the lift shaft, contained in the space defined on plan by the wall of the lift shaft and the adjacent cage wall, allows the cage for lifting in the shaft such that the top of the cage stands over the lower edges of the pulleys and/or beams, thus reducing also the minimum free height of the lift shaft head, between the upper extreme plan level and the same lift shaft ceiling. It is also possible to split the balance weight, realizing two units each having half weight, even more easily and advantageously placeable in narrow free spaces at the two cage sides.

As illustrative and not limiting herein there is disclosed a rope path referring to one of the multiple achievable solutions by using the object of the invention.

The ropes starting from the traction pulley towards the counterweight pass first sufficient times among the pulleys placed in the bottom of the shaft, such that the portion of the size ratio eventually not realized between the balance weight and the upper portion of the shaft can be realized between the cage and the lower portion of the shaft, so as to equalize on the whole the size ratio between the cage and the upper portion of the shaft.

The balance weight mass is to be chosen such that the rope pressure on the pulleys assures enough friction and mutual slides are prevented in every load and use condition of the cage, particularly in the full load braking or even in overloading conditions. Moreover the balance weight mass can also be chosen so as to partially compensate the cage weight, as much as minimum the power consumption is intended as well as the power to be installed for driving the lift.

The details of the expedients previously disclosed can be found in the invention above described, in some of the advantageous configurations.

Not limiting embodiments of the present invention are shown in the annexed drawings. In detail:

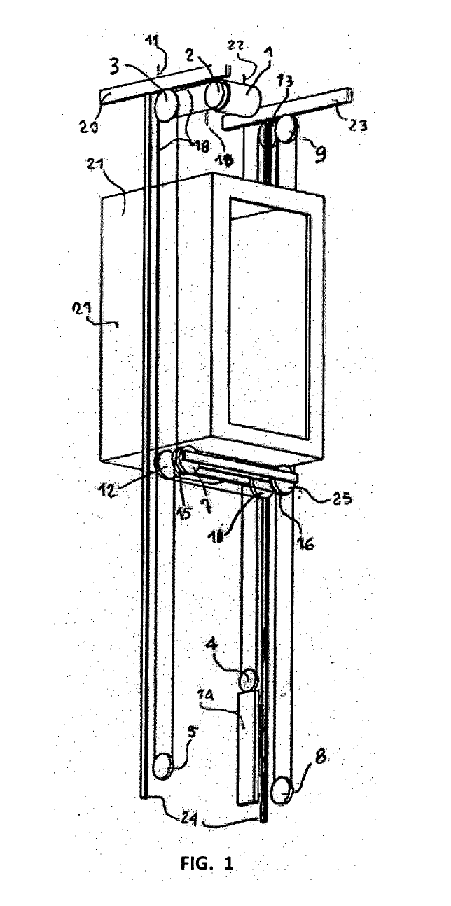

FIG. 1 is a perspective view of an embodiment of the lift with a balance weight according to the invention, with a cage suspension equal to 1:4 and motor on the top over the floor door,

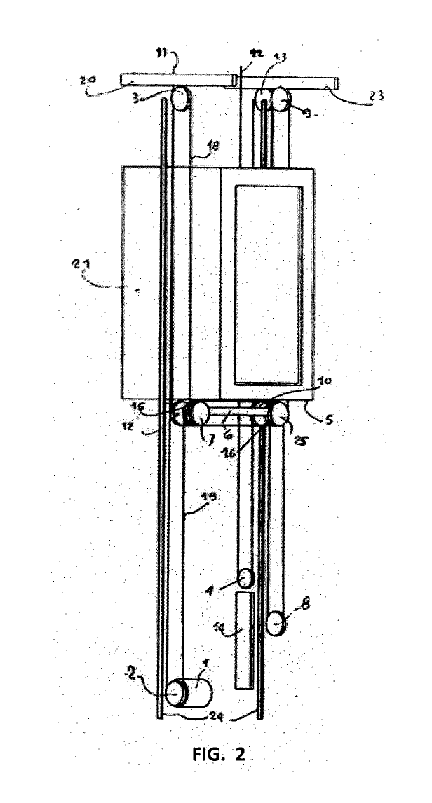

FIG. 2 is a perspective view of a further embodiment of the lift with a balance weight according to the invention, with cage suspension equal to 1:4 and cylindrical motor at the bottom under the floor sill,

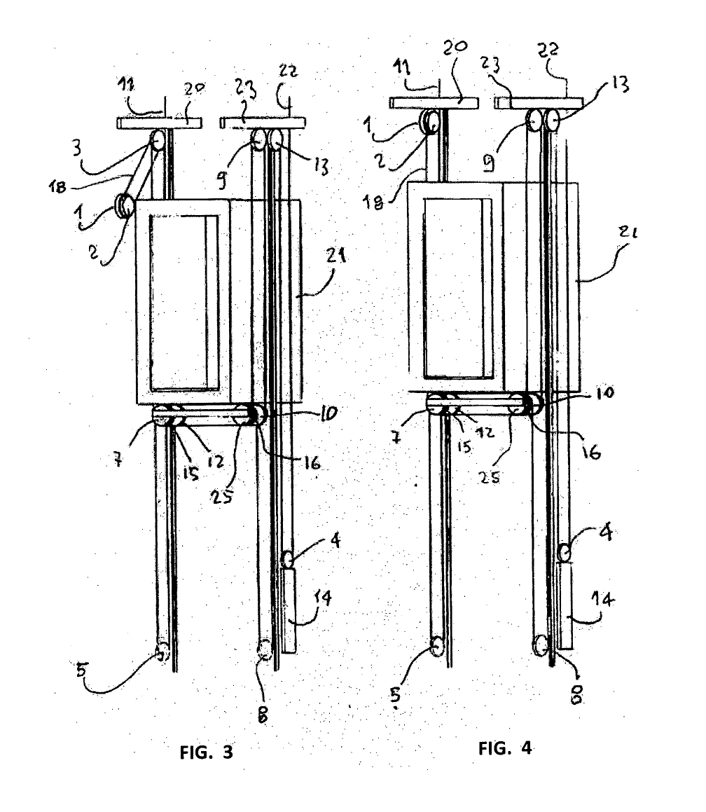

FIG. 3 is a group view of a lift according to the invention with cage suspension equal to 1:4 and flat motor beside the top floor door,

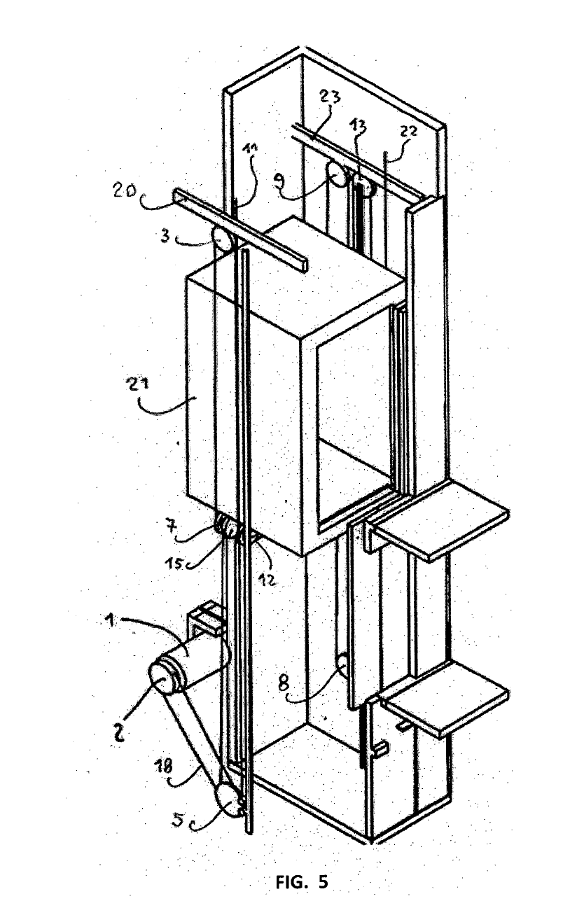

FIG. 4 is a group view of a lift according to the invention with cage suspension equal to 1:4 and flat motor on the top of the shaft,

FIG. 5 is a group view of a lift according to the invention with cage suspension equal to 1:4 and cylindrical motor at the bottom opposite to the floor door,

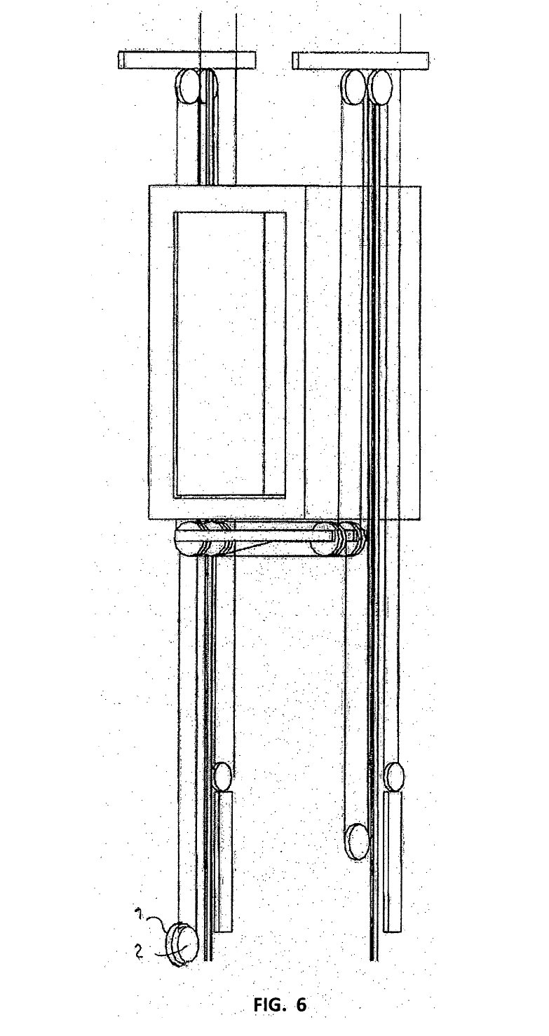

FIG. 6 is a group view of a lift according to the invention with cage suspension equal to 1:4 and splitting of the balance weight,

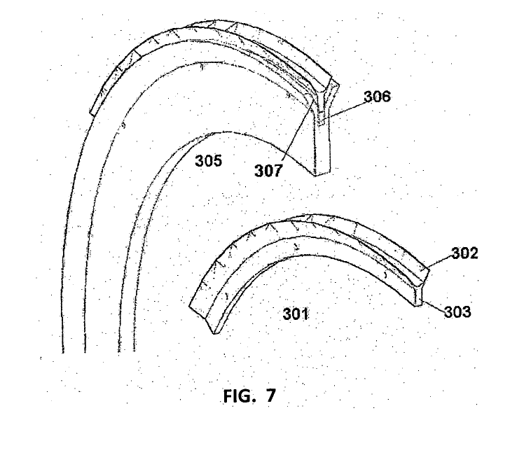

FIG. 7 is a perspective view of dowelling of the pulley races and the groove shape housing them object of the present invention,

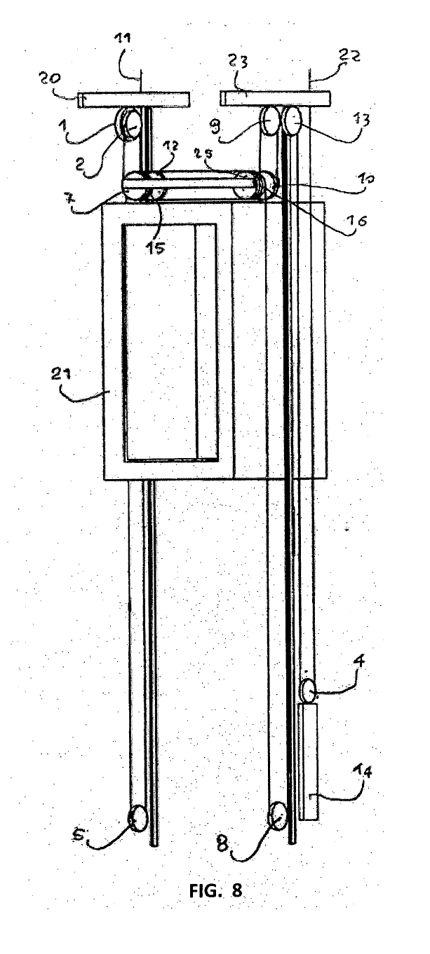

FIG. 8 is a group view of a lift according to the invention with cage suspension equal to 1:4 and pulley on the cage top,

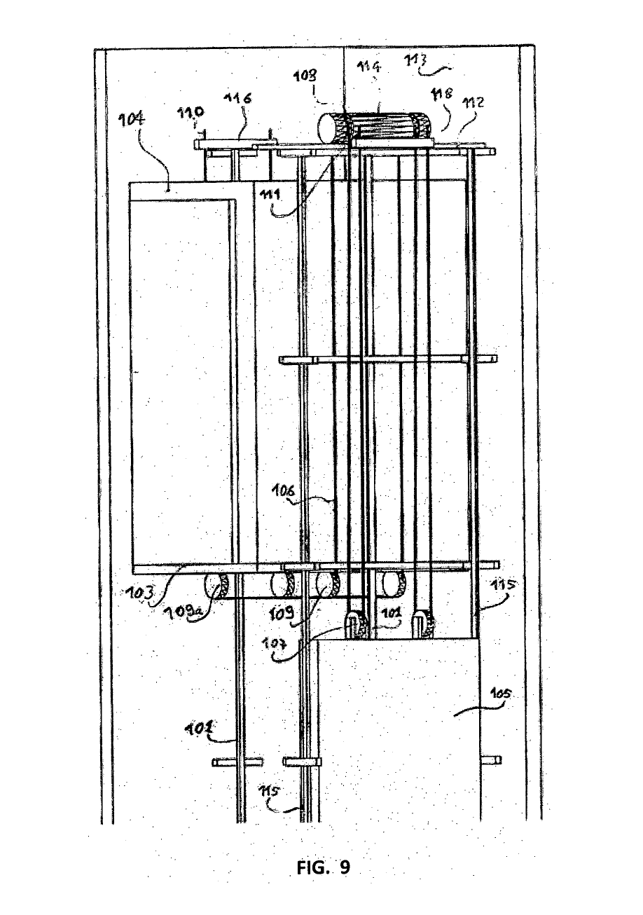

FIG. 9 is a group view of a further solution of lift according to the invention, having suspension equal to 1:2, and cage suspension pulleys placed crosswise under the cage floor,

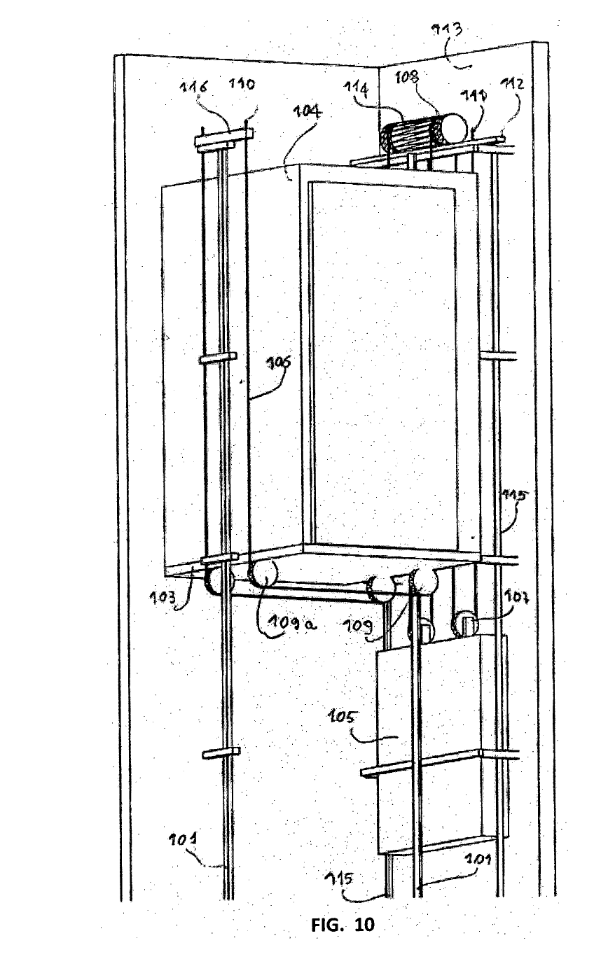

FIG. 10 is a second group view of lift shown in FIG. 9,

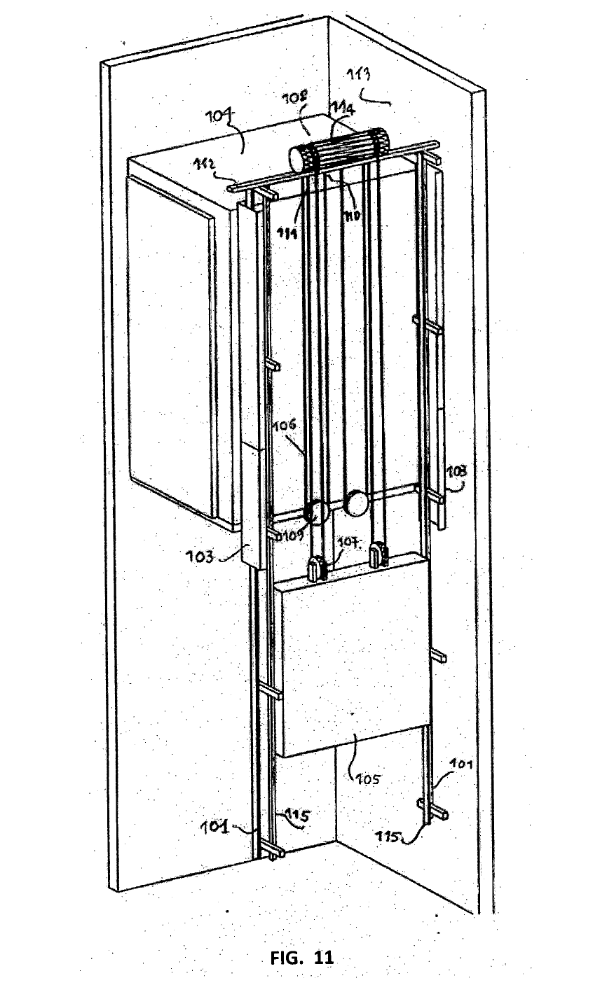

FIG. 11 is a group view of another solution of lift according to the invention, having suspension equal to 1:2, cage guide on the balance weight side and cage suspension pulleys place in the lower portion of the cage wall on the side where the balance weight stands. The splitting of the cage suspension pulleys contributes in reducing cross bulks,

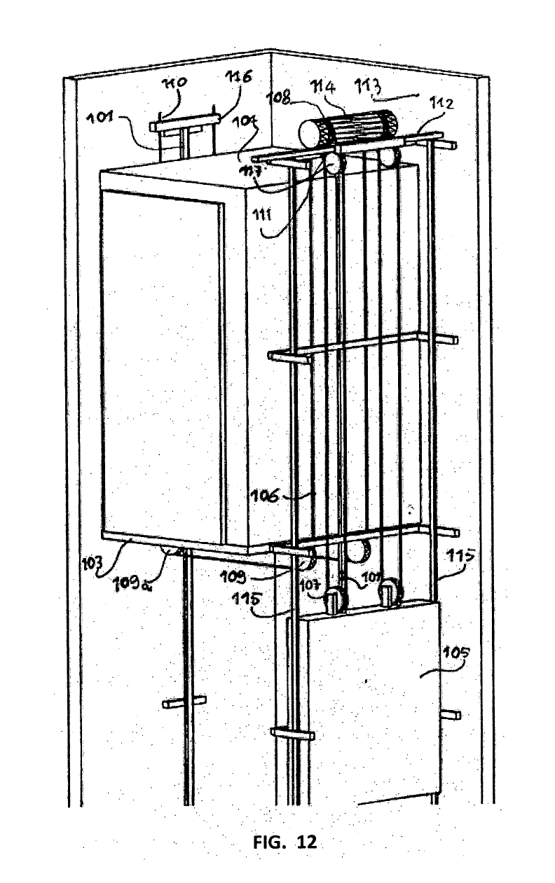

FIG. 12 is a group view of a further solution of lift according to the invention, having suspension equal to 1:2, cage suspension pulleys placed crosswise under cage floor and DW (Double Wrap) type traction,

FIG. 13 is a perspective view of an embodiment of a terminal element for fixing grooved belts according to the present invention,

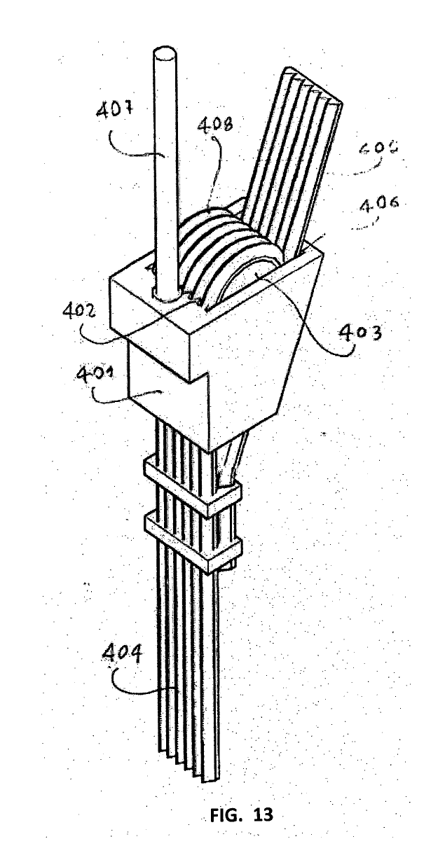

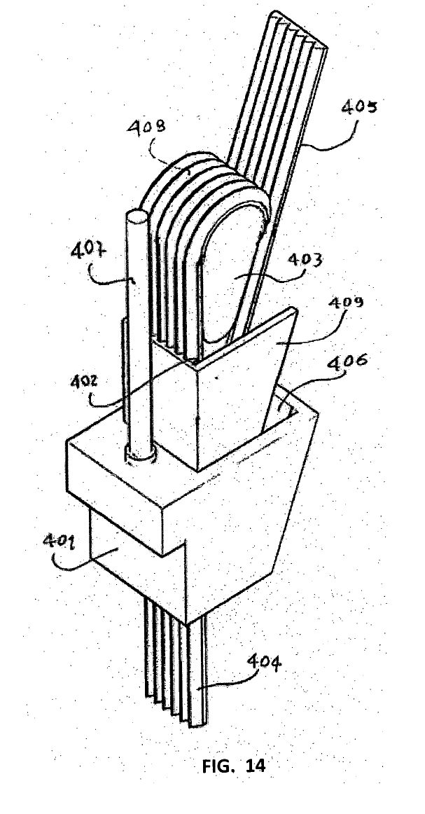

FIG. 14 is an exploded perspective view of the terminal element in FIG. 13,

FIG. 15 is a further perspective view of the terminal element in FIG. 13, and

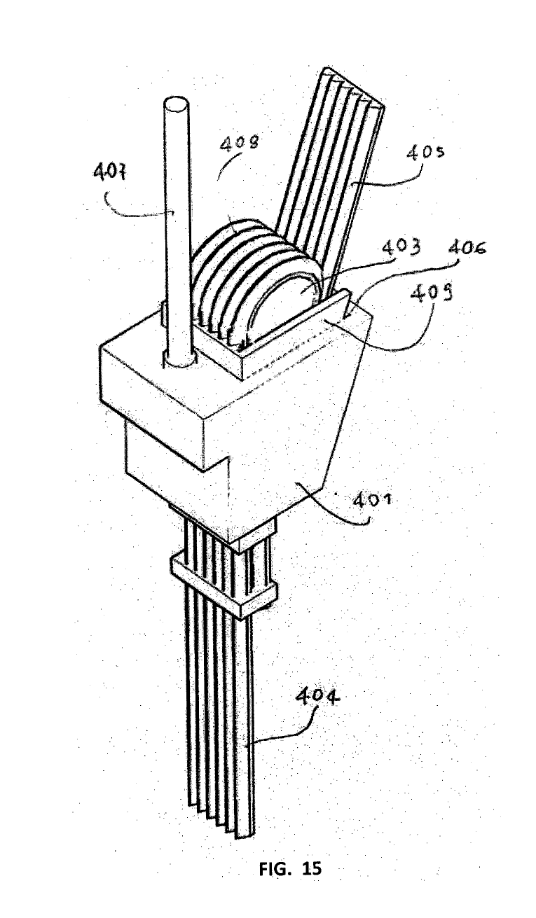

FIG. 16 is a perspective view of a detail of the terminal element in FIG. 13.

With reference to FIGS. 1 and 2 a motor 1 is shown, integral with a traction pulley 2 connected to a portion 19 of a rope which applies the size ratio between a balance weight 14 and the upper portion of the shaft. The rope portion 19 passes to a deflecting pulley 3, placed in a fixed position in respect of the building. Cage 21 slides between two vertical guides 24. The guiding device of the balance weight 14 is not illustrated. The cage side rope is fixed at one end to a point 11 of a crossbar 20, in turn fixed to the building over the cage 21 of the lift outside the cage projection, in an area comprised between a cage side and the lift shaft adjacent wall, and at other end to a fixed point 22 at a suspension crossbar 23, placed at the top of the lift shaft, on the side of the balance weight 14. The lift descent is realized by counterclockwise rotation of the traction pulley 2 and of a deflecting pulley 3, placed on the fix crossbar 20. A rope portion 18 adjusts the descent and the lift of a cage 21. The rope portion 18, in case of descent of the lift 21, passes on the pulleys 2 and 3 and around the upper half of a pulley 7 (placed under the cage), then around a pulley 25.

The rope 18 therefore rises and is wrapped around the upper half of a pulley 9, falls down and is partially wrapped around the upper half of a pulley 10, horizontally passes under the cage, is partially wrapped around the lower portion of a pulley 12 and rises again from it to be finally fixed at a point 11 on the crossbar 20.

The rope portion wrapped around the right half of the pulley 2, has next a simple wrapping around the pulley 3, falls downwards the pulley 5 and, once unwound around the lower half of this, rises again towards a pulley 15 and is wrapped around it, passes horizontally under the cage, is partially wrapped around the upper portion of a pulley 16, falls downwards the pulley 8, around lower half of which is wrapped, to rise again towards a pulley 13, placed at the lift shaft top. The rope is then wrapped around the upper half of the pulley 13 and falls downwards a suspension pulley 4 of the balance weight 14, to rise again towards the upper crossbar 23, on which a fixed point 22 is fixed.

With reference to FIG. 1 a motor 1 is shown, placed at the top inside the lift shaft outside the cage projection, over the floor door, the motor 1 is integral to a traction pulley 2 connected to a rope 18 being wrapped along an arc greater than 180 degrees around the deflecting pulley 3, placed on the fixing crossbar 20, in turn fixed to the building over the lift cage 21, outside the cage projection, in an area comprised between the cage vertical projection and the adjacent lift shaft wall. The cage 21 slides between vertical guides 24. The balance weight guide device is not shown. The rope is fixed at the cage side end to a point 11 of the crossbar 20 and at the other end to a fixed point 22, at a suspension crossbar 23, placed on the lift shaft top, at the side of the balance weight 14. The cage descent is obtained by clockwise rotation of the traction pulley 2 and deflecting pulley 3. The path of the pulley 18 is as follows: from the fixed point 11 it falls towards the pulley 12 placed under the cage, passes horizontally in respect of the pulley 10, around which is partially wrapped then rising towards the pulley 9, placed at the lift shaft top, is wrapped around it and falls again towards the pulley 25 around which is partially wrapped. From the pulley 25 it passes horizontally the pulley 7 from which it rises again towards the pulley 3, around which is wrapped for more than 180 degrees and it goes towards the pulley 2, crossing the track coming from pulley 7. Subsequently the rope is wrapped around the pulley 2 and it goes again towards the pulley 3, by which it is deflected downwards, on the direction of the pulley 5, the support of which is anchored in the bottom of the shaft, from this rises upwards the pulley 15, in the bottom of the cage, from which it goes horizontally towards the pulley 16, which deflects it upwards in the direction of the pulley 13, supported by the crossbar 23 place at the shaft top, in the opposite side in respect of the one in which the lifting machine stands.

From pulley 13 the ropes goes downwards to the suspension pulley 4 of the balance weight 14, is wrapped around it and goes again upwards in the direction of the upper fixing point 22, placed on the suspension crossbar 23.

With reference to FIG. 2 there is pointed out a motor 1 fixed at the lower portion of the lift shaft and partially projecting under the cage projection. The traction pulley 2 is integral with the motor 1.

The cage 21 slides between vertical guides 24. The guide device of the balance weight 14 is not shown. The cage side rope end is fixed on a fixed point 11 of the crossbar 20 and the other end on a fixed point 22, at a suspension crossbar 23, placed on the lift shaft top, on the side of the balance weight 14. To the crossbar 23 there are fixed the deflecting pulleys 9 and 13, placed outside the cage projection, as well as the deflecting pulley 3, fixed to the crossbar 20. The cage descent is obtained by clockwise rotation of the traction pulley 2 and deflecting pulley 3. The rope path is similar to the one described in FIG. 1, from which differs by the track comprised between the pulley 7 and pulley 15, which is above described.

From pulley 7 the rope goes upwards in the direction of the pulley 3, about which is wrapped then falling in the direction of the traction pulley 2, is wrapped around this and goes again upwards in the direction of the pulley 15, placed in the bottom of the cage.

In FIG. 3 there is pointed out a flat motor 1 placed at the top floor door, in a area adjacent the door and accessible outside the lift shaft, such that the bulk of the motor 1 and traction pulley 2 thereto integrally coupled is contained inside the space comprised between the horizontal cage projection towards the floor door and the motor side shaft wall.

The suspension rope 18 is wrapped around an arc greater than 180 degrees on the deflecting pulley 3, placed on the fixing crossbar 20, fixed in turn to the building over lift cage 21, outside the cage projection, in an area comprised between a cage side and the adjacent lift shaft wall.

The remaining description, comprised the rope path, is identical to what disclosed in the case illustrated in FIG. 1.

In FIG. 4 a there is shown a flat motor 1 placed at the lift shaft top outside the cage projection, in the area comprised between the vertical cage projection and the motor side lift shaft wall, the motor 1 is integral with the traction pulley 2.

The cage 21 slides between vertical guides 24. The guide device of the balance weight 14 is not shown. The cage side rope end is fixed to a fixed point 11 of the crossbar 20 and the other end to a fixed point 22, at a suspension crossbar 23, placed on the lift shaft top, on the side of the balance weight 14. To the crossbar 23 there are fixed the deflecting pulleys 9 and 13, placed outside the cage projection. The cage descent is obtained by clockwise rotation of the traction pulley 2 and the deflecting pulley 3. The rope path is similar to the one disclosed in FIG. 1, from which differs in the track comprised between the pulley 7 and the pulley 15, that is above described.

From the pulley 7 the rope goes upwards in the direction of the traction pulley 2, around which is wrapped the faking in the direction of the pulley 5, whose support is anchored in the lower portion of the shaft, is wrapped around the same and rises again towards the pulley 15 which is placed in the lower portion of the cage.

In FIG. 8 there is shown a flat motor 1 placed in the top of the lift shaft outside the cage projection, in the area comprised between the cage vertical projection and the motor side lift shaft wall, the motor 1 is integral to a traction pulley 2. The configuration is similar to the one illustrated in FIG. 4, except the fact that the cage supporting pulley are placed on the top of the same. Even the rope path is similar to the one disclosed in FIG. 4.

In FIGS. 9 and 10 there is shown a lift in which the cage 104 supported by a structure 103 slides vertically along the guides 101, connected to a balance weight 105 by an elongated connection element 106 fixed at its ends to fixed points 110, on the cage side, and 11, on the balance weight side.

The balance weight slides vertically along the guides 115.

The suspension of the cage and the balance weight is 1:2, with the elongated connection element 106 starting from the cage side fixing point 110, falls vertically towards a suspension pulley 109 placed in the bottom of the supporting structure of the cage, is partially wrapped around the pulley 109, passes transversely under the cage up to the pulley 109a placed on the opposite side of the cage, rises almost vertically towards the traction pulley 108a placed on the top of the shaft, is wrapped around the same then falling again towards the balance weight suspension pulley 107 on the cage guide on the balance weight side and is fixed on the top of lift shaft 113.

The pulley 108 is integral with the lifting machine 114, placed on the top at the head of the lift shaft 113, and supported by the upper supporting structure 112.

In FIG. 11 there is pointed out a lift in which the cage 104 supported by a structure 103 slides vertically along the guides 111, connected to a balance weight 105 by an elongated connection element 6 fixed at its ends to fixing point 10, on cage side, and 111, on balance weight side.

The balance weight slides vertically along the guides 115.

The suspension of the cage and the balance weight is 1:2, with the elongated connection element 106 starting from a cage side fixing point 110, falls vertically towards the suspension pulley 109 placed in the lower part of the cage supporting structure, is wrapped around the pulley 109, rises almost vertically towards the traction pulley 108 placed in the top of the lift shaft, is wrapped around the same then falling again towards the balance weight suspension pulley 107, is wrapped around the same and starts again upwards to be fixed at the support 111, placed on the upper supporting structure 112, which leans on the guides and is fixed on the upper portion of the lift shaft 113.

The pulley 108 is integral with the lifting machine 114, placed on the top at the head of the lift shaft 113, and supported by the upper supporting structure 112.

In FIG. 11 there is pointed out a lift in which the cage 104 supported by a structure 103 slides vertically along the guides 111, connected to a balance weight 105 by an elongated connection element 6 fixed at its ends to fixing points 10, on cage side, and 111, on balance weight side.

The balance weight slides vertically along guides 115.

The suspension of the cage and balance weight is 1:2, with the elongated connection element 106 starting from cage side fixing point 110, falls vertically towards the suspension pulley 109 placed in the lower portion of the cage supporting structure, Is wrapped around the pulley 109, rises almost vertically towards the traction pulley 108 placed in the top of the shaft, is wrapped around the same the falling again towards the balance weight suspension pulley 107, is wrapped around the same and starts again upwards to be fixed on the support 111, placed on the upper supporting structure 112, which leans on the guides and is fixed on the top of the lift shaft 113.

The pulley 108 is integral with the lifting machine 114, placed on the top at the head of the lift shaft 113, and supported by the upper supporting structure 112.

The elongated connection element 6, while passing from the pulley 109 to the pulley 108, rotates for a 90 degrees so as to couple suitably with both pulleys.

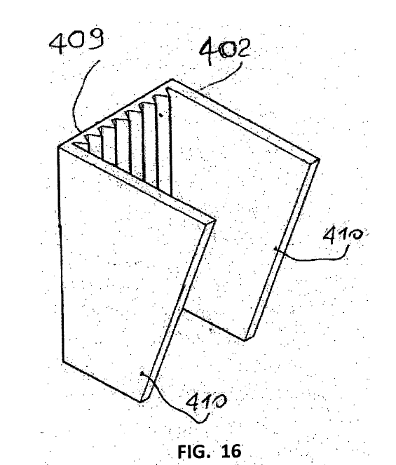

In FIG. 12 there is shown another version of lift of the same type illustrated in FIGS. 9 and 10, in the case in which the traction between the elongated connection element 106 and the traction pulley 108 is not sufficient to assure the right driving if the cage in any load condition. In such case the double wrapping (Double Wrap) solution can be advantageously adopted, in which a deflecting pulley 116 is added to the traction pulley 8, placed under the same and slightly shifted towards the balance weight side, such that the path of the elongated connection element 6 is developed as disclosed in the case of FIGS. 109 and 110, excepted the track between the pulley 108, the pulley 107 and the fixing point 1111, which is modified as follows:

The elongated element 106, once wrapped around the pulley 108, is wrapped around the pulley 116, returns towards the pulley 108, is wrapped around it and passes again on the pulley 116 from which it goes downwards in the direction of the balance weight suspension pulley 107. The suspension elongated element, once wrapped around the pulley 107 then rises almost vertically to be fixed to the support 112, in the fixing point 111.

In FIG. 7 there are shown a dowelling arc 301 of a pulley 305, whose only a race is herein shown for ease purpose, sectioned and with the dowelling arc 301, inserted in the circular race 307, with undercut 306. Moreover, the dowelling provides for a section with lateral wings 302, aim of which is to provide a protection and a lateral guide for the rope. The possibility to manufacture the pulley dowelling by dowelling arcs 301 separable one from another allows an easier replacement by segments, by rotating the pulley on which they are installed around an arc sufficient for an easy replacement, without removing the ropes in order to replace the whole circular dowel. This is a great advantage in terms of comfort and costs, considering the stop machine times and consequently the dowel maintenance. Once worn by friction the dowel filleted bottom where preferably the rope leans, this contacts the race metal surface, but for a portion is still leant on the dowel tang inserted into the undercut 306.

Still referring to FIG. 7, the function of the undercut 306 is either to provide a assembly and in-place holding system for the dowelling arcs 301, or, in case of wear of them, to assure a certain friction between the undercut 306 and the metallic ropes so as to allow for driving lift for a short period, even though not assuring a rope life comparable to the one achievable in presence of dowelling, due to the wear of the same by the contact with the undercut 306, which provides enough friction for driving in short periods, due to the excessive consumption of the ropes under these conditions.

When the cage and the balance weight are connected and supported by a longitudinally grooved belts, the belt ends must be fixed by a end cage joint, either to the balance weight, or to lift shaft. The terminal connection element of the belt must result so as to assure, safely, the transfer of the whole load acting on the same belt.

In the known manufacturing modes the belt is commonly fixed in a wedge-shaped housing by a wedge interfacing with the same housing. The supporting belt is placed between the two surfaces of the wedge-shaped housing and the wedge drags and hold the belt, by friction action, into the wedge-shaped housing. The surfaces of the wedge-shaped housing and the wedge are both smooth, with no grooves.

These types of terminal joints, either for flat belts or longitudinally grooved belts present the drawback that the compression load to be exerted by the wedge to assure enough friction between the belt and the wedge-shaped housing, so as to transmit safely and with reliability the plant supporting load to be exerted by the belt, is rather high and could, along the time, lead to damage of the belt in the fixing zone.

This particularly in case of grooved belts, which could suffer strains due to continuous pressure of the grooved portion against flat surface of the wedge-shaped housing.

The use of the belt 404 with longitudinal grooves presents the possibility to realize a terminal element 401 for fixing belt 404 able to use advantageously the presence of the grooves. As shown in FIG. 13, the grooves can be usefully coupled to a grooved surface 402 realized inside the wedge-shaped housing 406, on which by friction the stress transfer must be exerted between the belt 404 and the structure of the terminal element 401.

The greater friction being between the two grooved surfaces suitably interfaced, due to the wedge effect of the same grooves, allows for reducing the average pressure to be exerted between the belt 404 and the terminal element 401 for transmitting safely and with reliability the suspension force exerted by the belt. This allows for adopting a greater angle for the wedge 403 and the terminal element 401 in respect of the one necessary in the previous solution, and reducing sensibly the length of the coupling zone between the belt 404 and the terminal element 401.

In order to assure the maximum reduction of the compression stress applied to the belt 404 by the wedge 403, it is possible to insert, at the inclined surface of the wedge and the wedge-shaped housing, between the belt 404 and the surface 406 of the wedge-shaped housing which results without grooves, an independent track of belt 405 coupling to the grooved surface of the track of the belt 408 wrapping around the wedge 403.

This allows for avoiding that the grooved surface of the track 408 of the belt is compressed against a flat surface, avoiding the risk of damaging the elements of the groove.

At the zone in which there is fixed the supporting portion of the grooved belt, the upper surface of the terminal element is provided with a tie-rod 407 being used to transfer the stress of the belt to the fixing structure.

The grooved surface 402 formed inside the wedge-shaped housing 406 can be integral with the supporting structure of the terminal element 401 or can be also constituted by an independent element 409 suitably placed inside the wedge-shaped housing and adequately fixed to the structure of the terminal element 401.

The FIGS. 14 and 15 show one of the preferred solutions, which consists in realizing an independent grooved element 409, illustrated in FIG. 16, with two lateral tapered projections 410 which give it a open key-way wedge-shaped shape, which couples to the wedge-shaped shape inside the terminal element 401, locking inside it by effect of the force applied by the belt 404 and the corresponding locking wedge 403.

This allows the grooved surface of the track 408 for avoiding to be compressed against a flat surface, avoiding the risk of damaging groove elements.

At the zone wherein the supporting portion of the grooved belt is fixed, the upper surface of the terminal element is provided with a tie-rod 407 being used to transfer the belt stress to the fixing structure.

The grooved surface 402 formed inside the wedge-shaped housing 406 can be integral with the supporting structure of the terminal element 401 or can be also constituted by an independent element 409 suitably placed inside the wedge-shaped housing and adequately fixed to the structure of the terminal element 401.

FIGS. 14 and 15 show one of the preferred solutions, which consists in forming an independent grooved element 409, illustrated in FIG. 16, with two tapered lateral projections 410 which give it a key-way wedge-shaped shape, coupling to the wedge-shaped shape inside the terminal element 401, locking on the same due to the effect of the force applied on the belt 404 and the corresponding locking wedge 403.

To the skilled in the art it is clear that such solution is not the only possible, but there are other uncountable methods for fixing the grooved element, such as for example the use of a grooved slab with an upper 90 degrees projection; leaning onto the terminal element and is thereon held by using the fixing tie-rod 407 or other specific fixing element.

The lift object of the present invention can advantageously present other features object of further embodiments. They are herein schematically listed as illustrative not limiting:
Balance weight path equal to the cage path
Rope configuration on pulley 3 of the type Improved Double Wrap (IDW) so called by the double wrap they have around the pulley, improving friction
Splitting of the balance weight at the two sides of the lift in respect of the entry door
Cylindrical motor, that is having thickness size greater than diameter size
Flat motor, with thickness size lower than diameter size
Positioning of the cylindrical motor at the top over the floor door
Positioning of the cylindrical motor at the bottom opposite to the floor door
Positioning of the cylindrical motor at the top opposite to the floor door
Positioning of the flat motor at the top beside the floor door
Positioning of the flat motor at the bottom beside the floor door
Positioning of the flat motor at the top inside the shaft
Positioning of the flat motor at the bottom inside the shaft
Pulleys placed on the cage ceiling but not under the floor of the same
Suspension size ratio of the cage 1:6
Suspension size ratio of the cage 1:8
As mentioned, the cage suspension elongated elements can be ropes, flat belts with stiffening ropes or grooved belts with stiffening ropes.

1-28. (canceled)

29. A lift for buildings, without machine room, having a traction pulley (1) with a configuration of the pulleys and the suspension elongated elements in the lift shaft to achieve a suspension of the cage (21) with a ratio at least equal to 1:4 wherein the balance weight (14) of the cage (21), balancing only the cage side fixed weights, has a size ratio lower in respect of the one adopted far the suspension of the cage (21) and the size ratio is split into two parts, one defined by a balance weight (14) with ratio 1:2 and the other realized by a configuration of the develop of the suspension elongated elements going from the cage (21) and the lower portion of the shaft, to equalize on the whole the size ratio between the cage (21) and the upper portion of the shaft.

30. The lift according to claim 29 comprising the path of the balance weight (14) is equal to the path of the cage (21).

31. The lift according to claim 29 with Improved Single Wrap (ISW) traction, comprising the rope wrapping around the pulley in an angle range comprised about 200° and 300°, to increase friction, which is proportional to the rope wrapping angle around the pulleys, and with entry and exit of the ropes placed on the deflecting pulley, to place the motor and corresponding pulley into a niche accessible either from outside or inside the lift shaft, with no bulks in it.

32. The lift according to claim 29 with Improved Double Wrap (IDW) traction consisting in the rope wrapping around the pulley in an angle range comprised about 380° and 510° around the deflecting pulley and with entry and exit of the ropes placed on the deflecting pulley, to place the motor and corresponding pulley into a niche accessible from outside or inside the lift shaft, with no bulks in it.

33. The lift according to claim 29 with split of the balance weight (14) at the sides of the cage (21).

34. The lift according to claim 29, wherein a cylindrical or flat motor (1) is placed at any suitable position not interfering with the floor door.

35. The lift according to claim 29, wherein the cage size pulleys ore placed over the cage ceiling.

36. The lift according to claim 29, wherein the pulley dowelling is executed by dowelling arcs (301) with lateral wings (302) separate one from another and inserted in a circular race (307) of the pulleys with undercut (306).

37. The lift according to claim 29 wherein the suspension elongated elements comprise ropes, flat or grooved belts with stiffener ropes.

38. The lift without machine room according to claim 29 comprising the motor (1), integral with a traction pulley (2) connected to a portion of the suspension elongate element applying a size ratio between the balance weight (14) and the upper portion of the shaft; the portion (19) of suspension elongate element passes to a deflecting pulley (3), placed in a fixed position in respect of the building; the cage (21) slides among vertical guides (21); the cage side suspension elongated element is fixed at one end on a point (11) of a crossbar (20), fixed in turn to the guide and the building over the cage (21), and at the other end to a fixed point (22) at a suspension crossbar (23), place at the top in the lift shaft on the balance weight side; a portion (18) of the suspension elongated element applying the size ratio between the upper lift shaft and the cage (21) passes on the pulley (2, 3) and around the lower half of a pulley (7) placed under the cage (21) then around a pulley (25); the suspension elongated element (18) then rises and is wrapped around the upper half of a pulley (9), falls and is partially wrapped around the lower half of a pulley (10), passes horizontally under the cage (21) is partially wrapped around the lower section of a pulley (12) and rises again from it in order to be subsequently fixed at the point (11) on the crossbar (20); the portion of the suspension elongate element having been wrapped around the right half of the pulley (2), has then a simple wrap (Improved Single Wrap, ISW) around the pulley (3), falls towards the pulley (5) and, once been unwound around the lower half thereof, rises again and is wrapped around a pulley (15), passes horizontally under the cage, is partially wrapped around the upper section of a pulley (16), falls towards the pulley (8), around the lower portion of which is wrapped, then rising again towards a pulley (13), placed on the top of the lift shaft; the suspension elongated element is wrapped then around the upper half of the pulley (13) and falls towards a suspension pulley (4) of the balance weight (14), the rising again towards the upper crossbar (23), to which is fixed at a fixed point (22).

39. The lift without machine room according to claim 29 wherein a cage (104), supported by a structure (103), slides vertically along guides (101), connected to a balance weight (105) by a pair of connection elongated elements (106), each fixed at ends to the fixing points (110), on the cage side, and (111), on the balance weight side, the balance weight sliding vertically along the guides (115), the cage and balance weight suspension being double, each of 1:2 type, with each connection elongated element (106) starting from the cage side fixing point (110), falls vertically towards a suspension pulley (109a) placed in the lower portion of the cage supporting structure, passes transversely under the cage up to the pulley (109) placed at the opposite side of the cage, rises again almost vertically towards the traction pulley (108) placed in the top of the shaft, is wrapped around the same then falling again towards the balance weight suspension pulley (107), is wrapped around the same and starts again to be fixed on the support (111), placed at the upper supporting structure (118), leaning on the balance weight guides, on the balance weight side cage guides and is fixed to the top portion of the lift shaft (113), each pulley (108) being integral of the lifting machine (114), placed on the top at the head of the lift shaft (113), and supported by the upper supporting structure (112).

40. The lift without machine room according to claim 29 wherein a cage (104) supported by a structure (103) slides vertically along the guides (101), connected to a balance weight (105) by a pair of connection elongated elements (106), each fixed at the ends to a fixing points (110), on the cage side, and (111), on the balance weight side, the balance weight sliding vertically along the guides (115), the cage and balance weight suspension being double, each of the 1:2 type, with each connection elongated element (106) starting tram the cage side fixing point (110), falls vertically towards the suspension pulley (109) placed in the lower portion of the cage supporting structure, is wrapped around the pulley (109), rises again almost vertically towards the traction pulley (108), placed in the top of the shaft, is wrapped around the same the falling again towards the balance weight suspension pulley (107), is wrapped around the same and goes again upwards for being fixed to the support (111), placed on the upper supporting structure (112), leaning on the guides and is fixed to the top of the lift shaft (113), each pulley (108) being integral with the lifting machine (114), place on the top at the head of the lift shaft (113), and supported by the upper supporting structure (112), each connection elongated element (106), during passing between the pulley (109) and the pulley (108), rotating for 90° so as to couple suitably to both the pulleys.

41. The lift without machine room according to claim 29 in which a cage (104), supported by a structure (103), slides vertically along guides (101), connected to a balance weight (105) by a pair of connection elongated elements (106), each fixed at the ends to the fixing points (110), on the cage side, and (111), on the balance weight side, the balance weight sliding vertically along the guides (115), the cage and balance weight suspension being double, each of 1:2 type, and the traction is obtained by the double wrap DW (Double Wrap) solution, in which to each traction pulley (108) a deflecting pulley (117) is added; each connection elongated element (106) starts from the cage side fixing point (110), falls vertically towards a suspension pulley (109a) placed in the lower portion of the cage supporting structure, is partially wrapped around the pulley (109a), passes transversely under the cage up to the pulley (109) placed on the opposite side of the cage, rises almost vertically towards the traction pulley (108) placed in the top of the shaft, is wrapped around the pulley (117), returns to the pulley (108), is wrapped around it and passes again on the pulley (117) from which it goes downwards in the direction of the balance weigh suspension pulley (107); the suspension elongated element, after having been wrapped around the pulley (107) rises again almost vertically to be fixed to the support (111), placed on the upper supporting structure (112), leaning on the balance weight guides, on the cage guide on the balance weight side and is fixed to the top of the lift shaft (113), each pulley (108) being integral with the lifting machine (114), placed on the top at the head of the lift shaft (113), and supported by the upper supporting structure (112).

42. A terminal element (401) far fixing the grooved belt (404) for lift suspension, constituted by an hollow metallic structural element (401) with prefixed angle wedge-shaped housing (406) in which the grooved belt (404) is fixed by two sides of a locking wedge (403) with an angle equal to the one of the wedge-shaped housing (406), engaging the belt (404) in the wedge-shaped housing, wherein the inner surface of the wedge-shaped housing (406), on the side in which the track of the belt (404) supporting load is displaced, has grooves (402) interfacing to the grooves on the belt (404).

43. The terminal element (401) as claimed in claim 42, particularly having the grooved surface (402) inside the wedge-shaped housing is a part of an independent element (409) formed by a tapered member, with grooved surface (402) inside the perpendicular expansions (410) wedge-shaped, coupling with the wedge-shaped housing (406) of the fixing terminal element (401) and it is held in place due to the effect of the load acting in the grooved belt (404).

44. The terminal element as claimed in claim 42 wherein an independent track (405) of the grooved belt is inserted between the sloped surface of the wedge-shaped housing (406) and the grooved surface of the belt (404) wrapped around the locking wedge (403).

45. The terminal element as claimed in claim 43 wherein an independent track (405) of the grooved belt is inserted between the sloped surface of the wedge-shaped housing (406) and the grooved surface of the belt (404) wrapped around the locking wedge (403).

46. The lift according to claim 30 with Improved Single Wrap (ISW) traction, comprising the rope wrapping around the pulley in an angle range comprised about 200° and 300°, to increase friction, which is proportional to the rope wrapping angle around the pulleys, and with entry and exit of the ropes placed on the deflecting pulley, to place the motor and corresponding pulley into a niche accessible either from outside or inside the lift shaft, with no bulks in it.

47. The lift according to claim 30 with Improved Double Wrap (IDW) traction consisting in the rope wrapping around the pulley in an angle range comprised about 380° and 510° around the deflecting pulley and with entry and exit of the ropes placed on the deflecting pulley, to place the motor and corresponding pulley into a niche accessible from outside or inside the lift shaft, with no bulks in it.

48. The lift according to claim 47 with split of the balance weight (14) at the sides of the cage (21).
